(19) United States
(12) Patent Application Publication
(10) Pub. No.: US 2008/0190354 A1
(43) Pub. Date: Aug. 14, 2008

(54) DETECTION SYSTEM

(76) Inventors: Richard Edward Malpas, Ince (GB); Elaine McFarlane, Ince (GB); Keith Reading, Ince (GB); Robert Wilfred Matthews Wardle, Ince (GB)

Correspondence Address: SHELL OIL COMPANY, P O BOX 2463, HOUSTON, TX, 772522463, US

(21) Appl. No.: 11/929,421

(22) Filed: Oct. 30, 2007

(30) Foreign Application Priority Data
Oct. 30, 2006 (EP) 06255575.0

(51) Int. Cl. G01D 21/00

(52) U.S. Cl. 116/206

(57) ABSTRACT

Method for detecting a basic target species in a fuel composition, by (i) adding a spectroscopically active indicator which is capable of reacting with the target species, and (ii) detecting the spectroscopic response (suitably a colour change) of the fuel composition to the presence of the indicator. The method may be used to detect an additive such as a detergent or dispersant additive, in particular in an automotive gasoline or diesel fuel or a lubricating oil. Also provided is a kit for carrying out the method, in particular in the field. The indicator may be a phenolphthalein indicator such as tetrabromophenolphthalein ethyl ester (HTBPE).

### FIELD OF THE INVENTION

The present invention relates to a method and kit for detecting a target species in a fuel composition.

### BACKGROUND OF THE INVENTION

Additives can be included in fuel compositions, in particular automotive fuel compositions, for various purposes. Such additives include for example lubricity enhancers, static dissipators, cold flow additives, ignition improvers and corrosion inhibitors.

In particular it is common to include a detergent additive in a fuel composition, in order to reduce the level of deposits in an engine or other fuel-consuming system running on the fuel. Higher levels of such detergent additives may sometimes be included in so-called “premium” fuels.

It can often be desirable, for instance for quality control purposes, to verify the presence of a particular additive in a fuel composition, and/or to determine its concentration. However, there are currently very few straightforward tests available, for use in either the laboratory or in particular in the field, for determining the presence and/or concentration of a detergent additive in a fuel composition. Existing fuel analysis methods tend to suffer from drawbacks such as inapplicability to diesel, as opposed to gasoline, fuels; a requirement for complex or time consuming laboratory and analytical equipment or techniques; and/or calibration or standardisation issues, such as where the results vary according to the nature of the base fuel being tested.

At present, if the additive content of a fuel needs to be determined, a sample often has to be subjected to relatively complex, time-consuming and/or expensive chemical analyses, which may involve shipping the sample to an external laboratory. To determine the concentration of a typical amine-based detergent additive, for example, could involve chemical analysis of the nitrogen content of the fuel—such a technique would, however, be limited since typical detergent additive levels result in nitrogen concentrations of about 1 to 10 ppm whereas many routine analytical laboratories are only able to quantify nitrogen levels to a limit of 5 ppm.

### SUMMARY OF THE INVENTION

A method is provided for detecting a basic target species in a fuel composition, the method comprising (i) adding to the composition a spectroscopically active indicator which is capable of reacting with the target species, and (ii) detecting the spectroscopic response of the fuel composition to the presence of the indicator.

Another method is provided for signalling to a user a property of a fuel composition, the method involving including in the composition a target basic species and a spectroscopically active indicator which is capable of reacting with the target species, thereby producing a spectroscopic response in the fuel composition.

A kit is provided for use in detecting a basic target species in a fuel composition, the kit including (i) a spectroscopically active indicator which is capable of reacting with the target species and (ii) a reference with which to compare the spectroscopic response of a fuel composition to addition of the indicator.

### DETAILED DESCRIPTION OF THE INVENTION

It is an aim of the present invention to provide an alternative way of detecting additives in fuel compositions, embodiments of which can overcome or at least mitigate the above described problems.

According to a first aspect of the present invention there is provided a method for detecting a basic target species in a fuel composition, the method involving (i) adding to the composition a spectroscopically active indicator which is capable of reacting with the target species, and (ii) detecting the spectroscopic response of the fuel composition to the presence of the indicator.

The method may be for detecting the presence or otherwise of the target species in the fuel composition, and/or for detecting information about the concentration of the target species in the composition. In the latter case, the method may provide an approximate indication of the target species concentration (for example, indicating one or more ranges within which the target species concentration falls) and/or a more precise indication.

The term “fuel composition”, in the context of the present invention, naturally embraces a sample taken from a fuel composition, for instance for the purpose of carrying out the method of the present invention and/or another analytical test.

A basic target species is a species which acts as a base, which term includes a Lewis and/or Lowry-Brønsted base. It may be monomeric, oligomeric or polymeric, and will typically be organic. It may contain one or more nitrogen-containing basic groups selected for instance from amines, imines, amides, imides and succinimides. It may, for instance, contain one or more primary, secondary or tertiary amine groups, preferably selected from tertiary and secondary amine groups, more preferably tertiary.

In particular, the basic target species may be or contain a species selected from alkenyl succinimides, polybuteneamines, polyetheramines, bis-succinimides and mixtures thereof.

The target species may be any fuel component or additive which is present, or could be present (in particular, which is likely and/or suspected to be present) in the fuel composition. In an embodiment of the present invention, the target species is a fuel additive or constituent thereof—examples of additives which can contain basic species include detergents (which may contain organic amines, imides or succinimides such as those referred to above), stabilisers and antioxidants (which may include polyamines such as phenylenediamine), dispersants (which may contain polyamines or succinimides) and metal deactivators (which may contain diamines such as N,N′-disalicylidene-1,2-propanediamine). In particular, the target species may be a detergent or dispersant additive or constituent thereof. The method of the present invention may therefore be used to detect an additive, such as a detergent or dispersant additive, in a fuel composition.

A detergent of the type used in a fuel additive is an agent (suitably a surfactant) which can act to remove, and/or to reduce the build up of, combustion related deposits within a fuel combustion system, in particular in the fuel injection system of an engine such as in the injector nozzles. A dispersant is an agent which acts to keep solids suspended in the fuel, and hence to reduce their deposition on engine surfaces. The active ingredients of detergent and dispersant additives are typically basic in character and hence are suitable for detection using the method of the present invention.

Examples of known detergents include polyolefin substituted succinimides or succinamides of polyamines, for instance polyisobutylene succinimides or polyisobutylene amine succinamides, aliphatic amines, Mannich bases or reaction products of amines and polyolefin (e.g. polyisobutylene) maleic anhydrides. Succinimide dispersant additives are described for example in GB-A-960493, EP-A-0147240, EP-A-0482253, EP-A-613938, EP-A-0557516 and WO-A-98/42808.

Where the present invention is used to detect such an additive in a fuel composition, the additivated fuel composition suitably contains at least 10 mg/kg of the basic target species, such as at least 20 or 40 mg/kg. It may, for example, contain from 10 to 2000 mg/kg of the basic target species, or from 20 to 1000 or from 40 to 500 mg/kg. The method of the present invention may, however, be used to detect the absence of the additive, in which case the fuel composition may contain lower concentrations of the target species, or indeed none at all.

A “spectroscopically active” indicator is a substance which is capable of producing a change in the electromagnetic absorption, reflectance, transmission and/or emission spectrum of a fuel composition in which it is present—this change is the “spectroscopic response” of the composition to the presence of the indicator. Thus, a spectroscopic response is a change in the ability of the fuel composition to absorb, reflect, transmit and/or emit electromagnetic radiation, at any one or more wavelengths.

In the context of the present invention, a spectroscopically active indicator is any material (either an individual substance or a mixture of two or more substances) which is capable of producing such a spectroscopic response, for example a colour change, when added to a fuel composition which contains a basic target species. The indicator should thus be capable of signalling, spectroscopically and typically visually, information about a basic target species in a fuel composition in which it is present. Such information may be qualitative and/or quantitative. The spectroscopic response or signal will again typically be a visible signal such as a change in the colour of the fuel composition. The signal may occur only if the target species is present; if the target is not present it may then be the absence of the signal which conveys the desired information.

The indicator will typically be active in (i.e. produce a change in) the visible and/or ultraviolet (UV) ranges of the electromagnetic spectrum, more typically the visible range.

Thus, a spectroscopic response will typically be or involve a visible response, by which is meant a response which takes place in the visible region of the electromagnetic spectrum and is suitably detectable by the human eye. In other words, a visible response involves a change in the ability of the fuel composition to absorb, reflect, transmit and/or emit electromagnetic radiation in that part of the electromagnetic spectrum between the infrared and ultraviolet regions (referred to in this specification as “visible light”). In particular the response may be or involve a change in the colour of the fuel composition.

Typically, the indicator will be capable of generating a colour change in the fuel composition, on reaction with the basic target species.

It may be capable of generating two or more spectroscopically distinct responses, for example two or more distinct colours, dependent on the nature and/or concentration (typically the latter) of the target species in the composition. Typically the intensity of the colour change will also depend on the concentration of the basic target species present in the fuel composition. Thus, the method of the present invention may be capable of yielding at least two different results, each indicated by a different spectroscopic response (for example, visual signal) in the fuel composition.

The indicator must be capable of reacting with the target species, the term “reacting” embracing the formation of covalent, ionic, dative and hydrogen bonds as well as combinations thereof. Suitably, the indicator will be capable of forming a charge transfer complex with the target species. Such a complex may involve a chemical bond such as a hydrogen bond, a dative bond, a covalent bond or an ionic bond such as would occur on the formation of a dissociated ion pair between the two species (e.g. on donation of a proton by the indicator to a functional group present on the target species).

The reaction may involve a looser association between molecules and/or ions of the indicator and target species, so long as the thus-formed reaction product is capable of generating a detectable spectroscopic response in the fuel composition (e.g. it will typically be coloured).

Typically, a charge transfer complex will be formed between the indicator and an amine or imine group on the target species.

The indicator is thus suitably an acid, which term includes a Lewis and/or Lowry-Brønsted acid, and is suitably capable of donating a proton to, and/or of hydrogen bonding with, a base (such as an amine) so as to form a charge transfer complex and thus to produce a spectroscopic response. In particular, the indicator is capable of forming a coloured charge transfer complex with a base.

The indicator may thus be an acid/base indicator, which produces a spectroscopic response (typically a colour change) in response to a change in pH, the spectroscopic response typically taking place at a precise pH value.

Suitable acid/base indicators, capable of producing a colour change in response to the presence of a basic species such as an amine, include for example Bromophenol Blue, Bromocresol Green, Methyl Orange, Neutral Red and Nile Blue. Such indicators can exist in two distinctly different coloured chemical forms at different pHs, the transition from one to the other typically occurring rapidly and at a very clearly defined pH. They have not, however, been publicly used to detect a target species—in particular an additive—in a fuel composition.

Examples of commercially available acid/base indicators include those sold under the trade marks UNIMARK (ex. United Color Manufacturing, USA), MORTRACE MP (ex. Orgachim/Rohm & Haas) and DYEGUARD MARKER MP (ex. John Hogg Technical Solutions).

Preferably, the indicator will have a colour, on reaction with the basic target species, which is in the blue end of the visible spectrum, i.e. which suitably has a wavelength shorter than about 550 nm, preferably shorter than about 530 or 500 or 480 nm. Such colours tend to be more readily detected and distinguished, in particular in diesel fuel compositions (which are typically yellow or brown in colour), than colours such as red, orange, yellow or even green.

The indicator preferably produces a distinct change in colour, rather than a mere change in intensity of colour, in response to the presence of the basic target species.

In the method of the present invention, the indicator may be a phenolphthalein indicator, in particular tetrabromophenolphthalein or a derivative thereof such as a tetrabromophenolphthalein ester. It may be a tetrabromophenolphthalein alkyl ester such as tetrabromophenolphthalein ethyl ester (HTBPE) or a salt, in particular a metal salt, thereof, such as potassium tetrabromophenolphthalein ethyl ester (KTBPE). HTBPE, for example, is particularly suitable for use in the present invention, as it produces a distinct colour change from amber to blue on reaction with basic species such as amines, this being readily detectable even in coloured diesel fuels and even in the presence of additional basic species which may be included, albeit at lower concentrations than the target species, in a fuel composition.

The use of HTBPE to detect primary, secondary and tertiary alkylamines in a sample has been disclosed by Sakai et al in Analytical Chemistry, 69(9), 1766-1770. The authors observed the formation of reddish amine-HTBPE charge transfer complexes, the absorption maxima for which occurred at slightly different wavelengths dependent on the degree of substitution of the amine. They used spectrophotometry to detect, and distinguish between, the different complexes, and also investigated changes in their absorption spectra with temperature.

Sakai et al also observed the formation of blue charge transfer complexes when the ordinarily yellow HTBPE was added to 1,8-bis(N,N-dimethylamine)naphthalene, a highly basic amine which was believed to have reacted with the indicator to form a quaternary ammonium cation and TBPE anion pair.

There is, however, no suggestion by Sakai et al that such reactions might be used as the basis for detecting additive levels in fuel compositions, and the analytical techniques which they used would in particular be inappropriate for use in fuel sampling field tests.

According to the present invention, addition of the indicator may in some cases be achieved by adding to the fuel composition a suitable indicator precursor. An indicator precursor is a material (again either an individual substance or a mixture of two or more substances) which when included in a fuel composition is capable of subsequently generating a spectroscopically active indicator in response, for instance, to a change in a property of the composition, a specific event and/or a developing process. Generation of the indicator is in turn capable of producing a spectroscopic response in the composition.

In the method of the present invention, the spectroscopic response of the composition to the presence of the indicator may be or involve a change in the degree to which (i.e. the intensity with which) the composition absorbs, reflects, transmits and/or emits electromagnetic radiation, and/or in one or more of the wavelengths at which it absorbs, reflects, transmits and/or emits electromagnetic radiation. It will typically be a visible response, more typically a change in colour. This response may be detected by suitable spectroscopic means, for example by detecting a change in the electromagnetic absorption, reflectance, transmission and/or emission spectrum of the fuel composition on addition of the indicator, typically in the visible range as defined above.

A spectroscopic response may be detected by any suitable means, for instance spectroscopy (i.e. by investigating the electromagnetic absorption, reflectance, transmission and/or emission spectrum for the fuel composition at one or more wavelengths). In an embodiment of the present invention, the response is detected by the naked eye. Suitably, its detection involves assessing the colour of the fuel composition after, and optionally also before, addition of the indicator.

In general, references to “detecting” a spectroscopic response mean detecting either the presence, the absence and/or the nature and/or magnitude of such a response.

An indicator developing process may be required in order to detect the spectroscopic response. An indicator developing process is a process which induces a spectroscopic response in a fuel composition containing a spectroscopically active indicator, including if there was no previous spectroscopic response in the composition. A developing process thus allows detection of an indicator, where it may not previously have been detectable by spectroscopic means. Such a process may be of known type. It may involve, for instance, altering a condition of the fuel composition, such as its temperature. It may involve the addition of one or more reagents capable of inducing a chemical change in an indicator or indicator precursor or any other component present in the fuel composition. It may involve irradiation of the composition, for instance with UV radiation so as to cause an indicator to fluoresce. Typically, the developing process will elicit in the fuel composition a spectroscopic response which was not present prior to the developing process.

Suitably, however, in the method of the present invention, the spectroscopic response is capable of detection without such a developing process.

The method of the present invention may additionally involve comparing the detected spectroscopic response with one or more spectroscopic responses produced in reference fuel compositions, for instance compositions containing the indicator together with known concentrations (or concentrations within known ranges) of the target species. The detected response may be compared directly with a response from a reference composition, or indirectly for example using a spectrum, colour chart or other (typically graphic) representation of a response from a reference composition. Use of a colour chart or similar representation may make the method particularly suitable for use in a field test, for the relatively rapid and straightforward in situ testing of a fuel composition.

Comparison of the detected response with a reference response in this way can facilitate interpretation of the test result, helping a user to determine whether or not the fuel composition contains the target species and/or information about the concentration of the target species in the composition.

The present invention thus makes use of a relatively simple and inexpensive test procedure, capable of generating an immediately detectable and interpretable result. Such a test has the advantage that it can be performed by a relatively unskilled operator, and can be used in a simple laboratory environment or even, if necessary, in the field. It allows the immediate detection of a target species, and in cases also at least an estimate of the concentration of that species in the fuel composition under test. Thus, it may be used, for example, to distinguish between a fuel composition containing an additive at its “standard” treat rate and a so-called “premium” fuel composition containing a higher treat rate of the additive.

Embodiments of the present invention can, moreover, generate an immediately detectable result, without the need to “develop” the indicator in any way for instance by the addition of further reagents. It can be carried out in a single sample vessel, and requires addition of only one component (the indicator) to the fuel composition under test.

A method according to the present invention may, for example, be used for quality control or assurance purposes, for market research, for testing compliance with regulatory requirements or other relevant specifications, for detecting counterfeit products or for tracking the distribution or use of a fuel composition.

The method of the present invention is suitably carried out at a temperature from 18 to 30° C., such as from 21 to 25° C. or at about 23° C. It is suitably carried out at or around atmospheric pressure. Thus, the method may be carried out under ambient conditions, again making it suitable for use as a field test.

The method may be carried out in the presence of a suitable inert solvent, for example a hydrocarbon solvent such as toluene or an alkane (e.g. a C₅ to C₁₂ or C₅ to C₈ alkane, in particular n-heptane or n-hexane) or a mixture of two or more such solvents. The solvent may be added to the fuel composition before addition of the indicator.

The indicator may itself be used in the form of a solution in a suitable inert solvent, which solvent suitably does not interfere with the spectroscopic response of the fuel composition on addition of the indicator. Suitable such solvents include toluene, alcohols (in particular C₁ to C₈ or C₂ to C₆ alcohols) such as isopropanol, DCE and mixtures thereof.

A method according to the present invention may be used to detect a basic target species in any type of fuel composition, for example an automotive fuel composition. The fuel composition may for example be an automotive gasoline composition, of the type suitable for use in a spark ignition (petrol) internal combustion engine, or an automotive diesel composition of the type suitable for use in a compression ignition (diesel) internal combustion engine.

In general, the fuel composition may be selected from naphtha, kerosene, gasoline and diesel fuel compositions. It may be a middle distillate fuel composition, for example a heating oil, a lubricating oil (either industrial or automotive), an industrial gas oil, an on- or off-road automotive diesel fuel, a railroad diesel fuel, a marine fuel, a diesel fuel for use in mining applications or a kerosene fuel such as an aviation fuel or heating kerosene. Preferably, the fuel composition is for use in an engine such as an automotive engine or an aircraft engine. More preferably, it is for use in an internal combustion engine; yet more preferably, it is an automotive fuel composition. It may in particular be an automotive gasoline or diesel fuel composition, which is intended for, and/or adapted for, use in either a spark ignition or a compression ignition engine respectively.

It may be preferred for the fuel composition not to contain, or to contain only low levels (for example 100 mg/kg or less) of fuel additives containing acidic species (for example fatty acids, which may be present in corrosion inhibitors and lubricity additives). It may be preferred for the fuel composition not to contain, or to contain only low levels (for example 100 mg/kg or less) of fuel additives containing basic species (in particular amines) other than the target basic species (for example stabilisers, antioxidants or metal deactivators).

In an embodiment of the present invention, the fuel composition is, prior to addition of the indicator, colourless or substantially so, by which is meant that it is capable of transmitting all or substantially all visible light incident on it. Detection and interpretation of spectroscopic responses—in particular colour changes—in such fuels may be easier than in fuels which are themselves coloured. The fuel composition may, however, be coloured, for instance yellow or brown, as are many petroleum derived diesel base fuels.

The fuel composition will typically contain a major proportion (by which is meant typically 80% v/v or greater, more suitably 90 or 95% v/v or greater, most preferably 98 or 99 or 99.5 or 99.8% v/v or greater) of, or consist essentially or entirely of, a base fuel such as a distillate hydrocarbon base fuel, optionally (although subject to the comments above) together with one or more additional components such as fuel additives.

A base fuel may, for example, be a naphtha, kerosene or diesel fuel, preferably a diesel fuel. A naphtha base fuel will typically boil in the range from 25 to 175° C. A kerosene base fuel will typically boil in the range from 150 to 275° C. A diesel base fuel will typically boil in the range from 150 to 400° C.

The base fuel may in particular be a middle distillate base fuel, in particular a diesel base fuel, and in this case it may itself comprise a mixture of middle distillate fuel components (components typically produced by distillation or vacuum distillation of crude oil), or of fuel components which together form a middle distillate blend. Middle distillate fuel components or blends will typically have boiling points within the usual middle distillate range of 125 to 550° C. or 150 to 400° C.

A diesel base fuel may be an automotive gas oil (AGO). Typical diesel fuel components comprise liquid hydrocarbon middle distillate fuel oils, for instance petroleum derived gas oils. Such base fuel components may be organically or synthetically derived. They will typically have boiling points within the usual diesel range of 125 or 150 to 400 or 550° C., depending on grade and use. They will typically have densities from 0.75 to 1.0 g/cm³, preferably from 0.8 to 0.9 or 0.86 g/cm³, at 15° C. (IP 365) and measured cetane numbers (ASTM D613) of from 35 to 80, more preferably from 40 to 75 or 70. Their initial boiling points will suitably be in the range 150 to 230° C. and their final boiling points in the range 290 to 400° C. Their kinematic viscosity at 40° C. (ASTM D445) might suitably be from 1.5 to 4.5 mm²/s.

Such fuels are generally suitable for use in compression ignition (diesel) internal combustion engines, of either the indirect or direct injection type.

A petroleum derived gas oil may be obtained by refining and optionally (hydro)processing a crude petroleum source. It may be a single gas oil stream obtained from such a refinery process or a blend of several gas oil fractions obtained in the refinery process via different processing routes. Examples of such gas oil fractions are straight run gas oil, vacuum gas oil, gas oil as obtained in a thermal cracking process, light and heavy cycle oils as obtained in a fluid catalytic cracking unit and gas oil as obtained from a hydrocracker unit. Optionally, a petroleum derived gas oil may comprise some petroleum derived kerosene fraction.

Such gas oils may be processed in a hydrodesulphurisation (HDS) unit so as to reduce their sulphur content to a level suitable for inclusion in an automotive fuel composition. This also tends to reduce the content of other polar species such as oxygen- or nitrogen-containing species.

A base fuel may be or contain a so-called “biofuel” component such as a vegetable oil or vegetable oil derivative (e.g. a fatty acid ester, in particular a fatty acid methyl ester) or another oxygenate such as an acid, ketone or ester. Such components need not necessarily be bio-derived.

The fuel composition may have a low sulphur content, for example at most 1000 mg/kg. It may have a low or ultra low sulphur content, for instance at most 500 mg/kg, or no more than 350 mg/kg, or no more than 100 or 50 or 10 or even 5 mg/kg, of sulphur. It may be a so-called “zero-sulphur” fuel.

In an embodiment of the present invention, the fuel composition contains a Fischer-Tropsch derived fuel component. It may for example contain 1% v/v or greater, or 5% v/v or greater, or 10 or 15 or 20% v/v or greater, of a Fischer-Tropsch derived fuel component. The concentration of the Fischer-Tropsch derived fuel component may in cases be up to 100% or up to 99.99% v/v, such as up to 99.8 or 99.5 or 99 or 98% v/v, for example up to 75 or 50% v/v, or up to 40 or 30% v/v. For example, the concentration of the Fischer-Tropsch derived fuel component may be from 5 to 30% v/v.

It is already known to include Fischer-Tropsch derived fuel components in fuel compositions. Such components are the reaction products of Fischer-Tropsch condensation processes, for example the process known as Shell Middle Distillate Synthesis (van der Burgt et al, “The Shell Middle Distillate Synthesis Process”, paper delivered at the 5th Synfuels Worldwide Symposium, Washington D.C., November 1985; see also the November 1989 publication of the same title from Shell International Petroleum Company Ltd, London, UK). In particular, Fischer-Tropsch derived gas oils are known for inclusion in automotive diesel fuel compositions.

Fischer-Tropsch derived fuels tend to be colourless or substantially so, and may thus be less likely to affect any spectroscopic response produced by the indicator in the method of the present invention. They also typically contain lower levels of basic species, as compared for instance to petroleum derived fuels, and may thus be less likely to affect the response produced by a base-sensitive indicator.

In a fuel composition to which the method of the present invention is applied, the Fischer-Tropsch derived fuel component may be, for example, a Fischer-Tropsch derived naphtha, kerosene or gas oil, such as a gas oil.

By “Fischer-Tropsch derived” is meant that a fuel is, or derives from, a synthesis product of a Fischer-Tropsch condensation process. A Fischer-Tropsch derived fuel may also be referred to as a GTL (Gas-to-Liquid) fuel. The term “non-Fischer-Tropsch derived” may be construed accordingly.

The Fischer-Tropsch reaction converts carbon monoxide and hydrogen into longer chain, usually paraffinic, hydrocarbons:

n(CO+2H₂)═(—CH₂—)ₙ+nH₂O+heat,

in the presence of an appropriate catalyst and typically at elevated temperatures (e.g. 125 to 300° C., preferably 175 to 250° C.) and/or pressures (e.g. 5 to 100 bar, preferably 12 to 50 bar). Hydrogen:carbon monoxide ratios other than 2:1 may be employed if desired.

The carbon monoxide and hydrogen may themselves be derived from organic or inorganic, natural or synthetic sources, typically either from natural gas or from organically derived methane. The gases which are converted into liquid fuel components using such processes can in general include natural gas (methane), LPG (e.g. propane or butane), “condensates” such as ethane, synthesis gas (CO/hydrogen) and gaseous products derived from coal, biomass and other hydrocarbons.

Gas oil, naphtha and kerosene products may be obtained directly from the Fischer-Tropsch reaction, or indirectly for instance by fractionation of Fischer-Tropsch synthesis products or from hydrotreated Fischer-Tropsch synthesis products. Hydrotreatment can involve hydrocracking to adjust the boiling range (see, e.g., GB-B-2077289 and EP-A-0147873) and/or hydroisomerisation which can improve cold flow properties by increasing the proportion of branched paraffins. EP-A-0583836 describes a two step hydrotreatment process in which a Fischer-Tropsch synthesis product is firstly subjected to hydroconversion under conditions such that it undergoes substantially no isomerisation or hydrocracking (this hydrogenates the olefinic and oxygen-containing components), and then at least part of the resultant product is hydroconverted under conditions such that hydrocracking and isomerisation occur to yield a substantially paraffinic hydrocarbon fuel. The desired gas oil fraction(s) may subsequently be isolated for instance by distillation.

Other post-synthesis treatments, such as polymerisation, alkylation, distillation, cracking-decarboxylation, isomerisation and hydroreforming, may be employed to modify the properties of Fischer-Tropsch condensation products, as described for instance in U.S. Pat. No. 4,125,566 and U.S. Pat. No. 4,478,955.

Typical catalysts for the Fischer-Tropsch synthesis of paraffinic hydrocarbons comprise, as the catalytically active component, a metal from Group VIII of the periodic table, in particular ruthenium, iron, cobalt or nickel. Suitable such catalysts are described for instance in EP-A-0583836 (pages 3 and 4).

An example of a Fischer-Tropsch based process is the SMDS (Shell Middle Distillate Synthesis) described by van der Burgt et al in “The Shell Middle Distillate Synthesis Process”, supra. This process (also sometimes referred to as the Shell “Gas-To-Liquids” or “GTL” technology) produces middle distillate range products by conversion of a natural gas (primarily methane) derived synthesis gas into a heavy long chain hydrocarbon (paraffin) wax which can then be hydroconverted and fractionated to produce liquid transport fuels such as the gas oils useable in automotive diesel fuel compositions. A version of the SMDS process, utilising a fixed bed reactor for the catalytic conversion step, is currently in use in Bintulu, Malaysia and its gas oil products have been blended with petroleum derived gas oils in commercially available automotive fuels.

Gas oils, naphthas and kerosenes prepared by the SMDS process are commercially available, for instance, from Shell companies. Further examples of Fischer-Tropsch derived gas oils are described in EP-A-0583836, EP-A-1101813, WO-A-97/14768, WO-A-97/14769, WO-A-00/20534, WO-A-00/20535, WO-A-00/11116, WO-A-00/11117, WO-A-01/83406, WO-A-01/83641, WO-A-01/83647, WO-A-01/83648 and U.S. Pat. No. 6,204,426.

By virtue of the Fischer-Tropsch process, a Fischer-Tropsch derived fuel has essentially no, or undetectable levels of, sulphur and nitrogen. Compounds containing these heteroatoms tend to act as poisons for Fischer-Tropsch catalysts and are therefore removed from the synthesis gas feed. Further, the Fischer-Tropsch process as usually operated produces no or virtually no aromatic components: the aromatics content of a Fischer-Tropsch derived fuel, suitably determined by ASTM D4629, will typically be 1% w/w or below, preferably 0.5% w/w or below and more preferably 0.1% w/w or below.

Generally speaking, Fischer-Tropsch derived fuels have relatively low levels of polar components, in particular polar surfactants, for instance compared to petroleum derived fuels. Such polar components may include for example oxygenates, and sulphur- and nitrogen-containing compounds. A low level of sulphur in a Fischer-Tropsch derived fuel is generally indicative of low levels of both oxygenates and nitrogen-containing compounds, since all are removed by the same treatment processes.

Where a Fischer-Tropsch derived fuel component is a naphtha fuel, it will be a liquid hydrocarbon distillate fuel with a final boiling point of typically up to 220° C. or preferably of 180° C. or less. Its initial boiling point is preferably higher than 25° C., more preferably higher than 35° C. Its components (or the majority, for instance 95% w/w or greater, thereof) are typically hydrocarbons having 5 or more carbon atoms; they are usually paraffinic.

In the context of the present invention, a Fischer-Tropsch derived naphtha fuel preferably has a density of from 0.67 to 0.73 g/cm³ at 15° C. and/or a sulphur content of 5 mg/kg or less, preferably 2 mg/kg or less. It preferably contains 95% w/w or greater of iso- and normal paraffins, preferably from 20 to 98% w/w or greater of normal paraffins. It is preferably the product of a SMDS process, preferred features of which may be as described below in connection with Fischer-Tropsch derived gas oils.

A Fischer-Tropsch derived kerosene fuel is a liquid hydrocarbon middle distillate fuel with a distillation range suitably from 140 to 260° C., preferably from 145 to 255° C., more preferably from 150 to 250° C. or from 150 to 210° C. It will have a final boiling point of typically from 190 to 260° C., for instance from 190 to 210° C. for a typical “narrow-cut” kerosene fraction or from 240 to 260° C. for a typical “full-cut” fraction. Its initial boiling point is preferably from 140 to 160° C., more preferably from 145 to 160° C.

A Fischer-Tropsch derived kerosene fuel preferably has a density of from 0.730 to 0.760 g/cm³ at 15° C.—for instance from 0.730 to 0.745 g/cm³ for a narrow-cut fraction and from 0.735 to 0.760 g/cm³ for a full-cut fraction. It preferably has a sulphur content of 5 mg/kg or less. It may have a cetane number of from 63 to 75, for example from 65 to 69 for a narrow-cut fraction or from 68 to 73 for a full-cut fraction. It is preferably the product of a SMDS process, preferred features of which may be as described below in connection with Fischer-Tropsch derived gas oils.

A Fischer-Tropsch derived gas oil should be suitable for use as a diesel fuel, ideally as an automotive diesel fuel; its components (or the majority, for instance 95% w/w or greater, thereof) should therefore have boiling points within the typical diesel fuel (“gas oil”) range, i.e. from 150 to 400° C. or from 170 to 370° C. It will suitably have a 90% w/w distillation temperature of from 300 to 370° C.

A Fischer-Tropsch derived gas oil will typically have a density from 0.76 to 0.79 g/cm³ at 15° C.; a cetane number (ASTM D613) greater than 70, suitably from 74 to 85; a kinematic viscosity (ASTM D445) from 2 to 4.5, preferably from 2.5 to 4.0, more preferably from 2.9 to 3.7, mm²/s at 40° C.; and a sulphur content (ASTM D2622) of 5 mg/kg or less, preferably 2 mg/kg or less.

Preferably, a Fischer-Tropsch derived fuel component used in the present invention is a product prepared by a Fischer-Tropsch methane condensation reaction using a hydrogen/carbon monoxide ratio of less than 2.5, preferably less than 1.75, more preferably from 0.4 to 1.5, and ideally using a cobalt containing catalyst. Suitably, it will have been obtained from a hydrocracked Fischer-Tropsch synthesis product (for instance as described in GB-B-2077289 and/or EP-A-0147873), or more preferably a product from a two-stage hydroconversion process such as that described in EP-A-0583836 (see above). In the latter case, preferred features of the hydroconversion process may be as disclosed at pages 4 to 6, and in the examples, of EP-A-0583836.

Suitably, in accordance with the present invention, a Fischer-Tropsch derived fuel component will consist of at least 70% w/w, preferably at least 80% w/w, more preferably at least 90% w/w, most preferably at least 95 or 98 or even 99% w/w, of paraffinic components, preferably iso- and normal paraffins. The weight ratio of iso-paraffins to normal paraffins will suitably be greater than 0.3 and may be up to 12; suitably it is from 2 to 6. The actual value for this ratio will be determined, in part, by the hydroconversion process used to prepare the fuel from the Fischer-Tropsch synthesis product.

The olefin content of the Fischer-Tropsch derived fuel component is suitably 0.5% w/w or lower.

According to the present invention, the fuel composition being tested may contain a mixture of two or more Fischer-Tropsch derived fuel components.

A second aspect of the present invention provides a kit for use in detecting a basic target species in a fuel composition, the kit including (i) a spectroscopically active indicator which is capable of reacting with the target species and (ii) a reference with which to compare the spectroscopic response of a fuel composition to addition of the indicator.

Such a test kit may be used to carry out a method according to the first aspect of the present invention.

The reference will suitably comprise a representation (for example a graphic representation) of a spectroscopic response produced in one or more reference samples containing known concentrations (or concentrations within known ranges) of the target species. It may, for example, take the form of a colour chart; a printed spectrum such as an electromagnetic absorption, reflectance, transmission and/or emission spectrum; a calibration plot of absorption, reflectance, transmission and/or emission properties against target species concentration at one or more relevant wavelengths; or a data table.

The reference will preferably comprise a colour chart, showing the colour(s) of one or more suitable reference compositions, for instance the colour(s) observed when the indicator is added to one or more fuel compositions containing known concentrations (or concentrations within known ranges) of the relevant target species.

The colour charts may include colours for two or more different fuel compositions, for example for fuel compositions having different initial colours; this can allow test results to be more readily interpreted, whatever the colour of the fuel composition being tested.

The colour charts may include colours for two or more different target species, allowing the test kit to be used to detect a range of potential constituents of a fuel composition.

A kit according to the second aspect of the present invention may optionally also include one or more of the following:
(a) a sample vessel in which to collect a sample of a fuel composition under test and contact it with the indicator;
(b) a solvent—for example n-heptane, n-hexane, toluene or a mixture thereof—with which to dilute a sample of the fuel composition under test;
(c) instructions for using the kit in order to detect the target species in a test fuel composition (such instructions may be written and/or recorded on another training medium such as a computer disk, video or DVD);
(d) apparatus for use in detecting a spectroscopic response—for example a spectrophotometer—or to assist in its detection—for example a light box to aid reading of a colour chart or assessment of a coloured test sample;
(e) means for developing the indicator, for example a UV lamp to “develop” a fluorescent indicator, or one or more additional reagents;
(f) a cleaning composition, such as a solvent or solvent mixture, for use in cleaning a sample vessel prior to use;
(g) conventional hardware selected for instance from sampling pipettes, stirrers and the like; and
(h) safety equipment selected, for instance, from disposable gloves, safety goggles, containers for disposing of sharps and waste vessels in which to dispose of used fluids such as solvents and fuel samples.

Such a test kit may be suitable and/or adapted and/or intended for use either in a laboratory or in the field, preferably at least the latter. In the latter case, it may be preferred for the kit not to include apparatus for detecting a spectroscopic response, but for the operator to be required to detect the response by eye. Such a kit may, however, include apparatus, such as a light box, to assist in detection of a spectroscopic response.

In a kit which is suitable and/or adapted and/or intended for use in the field, the reference with which to compare the spectroscopic response of a fuel composition suitably comprises one or more colour charts.

The indicator will suitably be provided in solution in an inert solvent, as described above in connection with the first aspect of the present invention. It is suitably stored at a pH of 7 or below prior to its addition to a fuel composition under test. In many cases it will be desirable to store the indicator under conditions which prevent or at least reduce its degradation, for example in a light-, moisture- and/or oxygen-free environment. In particular, the indicator may be provided in closed (typically glass) vessels under an inert gas such as argon.

A third aspect of the present invention provides a fuel composition containing a spectroscopically active indicator which is capable of reacting with a basic species, such as a fuel additive or constituent thereof, and thereby producing a spectroscopic response in the composition. Such a composition suitably also contains a basic species, for example in a fuel additive. In an embodiment of this aspect of the present invention, the basic species is a detergent additive.

A fourth aspect of the present invention provides a method for signalling to a user a property of a fuel composition, the method involving including in the composition a basic species (typically a fuel additive or constituent thereof) and a spectroscopically active indicator which is capable of reacting with the basic species, thereby producing a spectroscopic response in the fuel composition. The spectroscopic response, which will typically be a colour or colour change, may then be used to indicate the presence and/or the quantity of the basic species, in particular a detergent additive or constituent thereof, in the composition.

In this context, a “user” includes any person or body involved in the supply, transportation, storage, testing or use of the composition or the handling of the composition for any other purpose.

A method according to the present invention may be used as part of a method for increasing customer loyalty and in turn market share, or of a method for reassuring customers of quality standards, or of a method for detecting counterfeit or illegally traded products, or of a method for quality control of fuel compositions, or of a method for managing the distribution of fuel compositions to users, or of a method for monitoring the areas of use, storage and/or disposal of fuel compositions.

Throughout the description and claims of this specification, the words “comprise” and “contain” and variations of the words, for example “comprising” and “comprises”, mean “including but not limited to”, and do not exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Preferred features of each aspect of the present invention may be as described in connection with any of the other aspects.

Other features of the present invention will become apparent from the following examples. Generally speaking, the present invention extends to any novel one, or any novel combination, of the features disclosed in this specification (including any accompanying claims and drawings). Thus, features, integers, characteristics, compounds, chemical moieties or groups described in conjunction with a particular aspect, embodiment or example of the present invention are to be understood to be applicable to any other aspect, embodiment or example described herein unless incompatible therewith.

Moreover, unless stated otherwise, any feature disclosed herein may be replaced by an alternative feature serving the same or a similar purpose.

The following non-limiting examples illustrate the use of methods and kits in accordance with the present invention.

### EXAMPLE 1

This example demonstrates the suitability of a method according to the present invention for determining the presence, and the approximate concentration, of an amine-based detergent additive in a number of diesel fuels.

The indicator used was 3′,3″,5′,5″-tetrabromophenolphthalein ethyl ester (Bromophthalein Magenta E, CAS No. 1176-74-5) (HTBPE), dissolved to a concentration of 0.04% w/w in a 1:1 mixture of toluene and isopropanol. This indicator solution is initially green in colour, and remains so when present in a neutral or acidic environment. In an alkaline environment, the indicator is magenta in colour.

The fuels tested were:
F1 a commercially available petroleum derived automotive gas oil (containing 5220 mg/kg sulphur), obtained from South Africa;
F2 a commercially available “low sulphur diesel”, again petroleum derived, obtained from Hungary;
F3 a commercially available petroleum derived “ultra low sulphur diesel”, obtained in the UK;
F4 & F5 Fischer-Tropsch derived gas oils, ex. Shell; and
F6 a commercially available petroleum derived Swedish diesel fuel (containing 5 mg/kg sulphur).

Samples of each of these fuels were blended with 250 and 500 mg/kg of a commercially available amine-based detergent additive package, OMA 4130D (ex. Innospec), containing a PIB polyamine succinimide detergent as an active ingredient.

The indicator solution was then added to each sample, and also to an unadditivated sample of each fuel, and the sample colours compared by eye. In each case, 3 ml of fuel was combined with 7 ml of either n-heptane or n-hexane and 2 ml of indicator solution.

The observed colour changes are detailed in Table 1 below.

TABLE 1

| | F1 | F2 | F3 | F4 | F5 | F6 |
|---|---|---|---|---|---|---|
| Base fuel | Straw | Yellow | Yellow | Colourless | Colourless | Colourless |
| | yellow | | | | | |
| Base fuel + | Brown | Brown | Brown | Yellow | Yellow | Yellow |
| indicator | | | | | | |
| Base fuel + | Green | Grey- | Deep | Grey- | Green | Grey- |
| indicator + | | green | grey- | green | | green |
| 250 mg/kg additive | | | green | | | |
| Base fuel + | Grey- | Grey- | Grey- | Blue | Deep | Blue |
| indicator + | blue | blue | blue | | blue | |
| 500 mg/kg | | | | | | |
| additive | | | | | | |

These data show that the method of the present invention may be used to detect the presence, and the approximate treat rate, of an amine-based detergent additive in a diesel fuel composition. For each fuel, the different detergent concentrations give rise to different colours, based on which an operator can determine whether the fuel composition contains the detergent at its standard treat rate or at a higher level. This in turn could be used, for example, for quality control, customer reassurance, product tracking or verification, fraud detection or many other commercial, technical or legal purposes.

Because the results take the form of colour changes, they can be readily assessed and interpreted by eye, without the need for complex, cumbersome or expensive analytical equipment. This makes the invented method particularly suitable for use away from the laboratory, by unskilled operators and often on relatively small fuel samples. A suitable test kit, for use in the field, is, for instance, described in Example 3 below.

To aid interpretation of the test results, it may be desirable to supply the operator with a reference colour chart, showing the colours observed on adding the same indicator to fuels of known type and containing known concentrations of the additive being detected. For any given test sample, the operator then needs to compare the colour observed on addition of the indicator with the colours shown on the reference charts for a fuel having the same initial colour.

It is of note that the three colourless fuels F4 to F6 generally gave rise to more vivid and intense colours, and to colours—at the various different detergent concentrations—that could more readily be distinguished from one another. The present invention may therefore be of particular use in testing such fuels, or compositions containing such fuels.

It is thought that the colourless fuels are less likely to interfere with or otherwise mask the colour of the indicator. It may also be the case that the low levels of aromatic, olefinic and heteroatom-containing species in the Fischer-Tropsch derived gas oils, and/or their inherently low basicity, reduce the extent to which they can interfere with the chemistry of the test, compared, for example, to the conventional petroleum derived fuels.

### EXAMPLE 2

A test similar to that described in Example 1 may also be carried out in a laboratory, as described below. In this case, a spectrophotometer is used to read the spectroscopic response generated on addition of the indicator to a fuel sample, thus potentially yielding a more precise indication of the target species concentration.

Again this test is capable of determining the approximate concentration of an amine-containing additive in a fuel composition such as an automotive diesel or gasoline fuel. Typically it can be used to detect additive concentrations over the range from 0 to 800% of the nominal treat rate.

HTBPE is again used as the indicator. The solid HTBPE dye is dissolved in a mixture of toluene and isopropanol (1:1 w/w, both HPLC grade) to a concentration of 0.04% w/w. This solution, which is initially green in colour, should be stored in a dark, moisture-free environment and at ambient temperature prior to use, and should ideally be freshly prepared immediately before the test. Its percent transmittance at 570 nm is between 75 and 85%. In an alkaline environment, in contrast, the HTBPE solution turns magenta in colour, with an absorbance maximum at 570 nm.

Test samples can be prepared by mixing the HTBPE solution with test fuels and toluene, in each case adding 1 ml of the indicator solution. Toluene is used to dilute the fuel samples, at an appropriate level determined according to the inherent basicity of the base fuel present (or likely to be present) in the samples.

The light transmittance of the test samples, at 570 nm, is then probed using a spectrophotometer, for example a Palintest™ 5000 portable spectrophotometer (which measures percent transmittance), and compared to that of a colourless reference solution which has been assigned a nominal transmittance of 100%. Transmittance values (% T) can be converted to percent absorbance values using the equation:

% absorbance=log₁₀(100% T).

Percent absorbance values should also be determined for calibration solutions containing the relevant base fuel blended with the relevant target species at a number of known concentrations. For example, if the test is to be used to detect an additive X, and may need to be carried out on fuel samples containing base fuels of types A, B and C, then suitable calibration solutions might contain the base fuels A, B and C, blended with X at 0, 50, 100 and 200% of its normal treat rate (i.e. 12 solutions in total). From these, calibration graphs of % T, or a related parameter, against additive concentration can be prepared, with which future test samples can be compared.

All tests should be carried out at ambient temperature (suitably 23° C.±2° C.).

According to this test method, spectrophotometric means are used to probe the electromagnetic absorption, reflectance, transmission and/or emission spectrum (typically the absorption and/or transmission spectrum) of test samples. The degree of any change to these spectra will be proportional to the concentration of any charge transfer complex formed between the indicator and the target additive. Thus, for example, in the present case, the degree of absorbance at 570 nm indicates the concentration of a detergent additive, typically an amine-containing additive such as OMA 4130D (ex. Innospec), present in a sample.

### EXAMPLE 3

### Field Test Kit

A test kit in accordance with the present invention, for use in conducting field tests on, for example, diesel fuels, comprises:
(a) an appropriate quantity (for example in 2 ml ampoules) of an indicator such as HTBPE, in a suitable solvent such as in Example 1.
(b) reference colour charts, which depict the colours observed when the indicator is added to fuel compositions containing known concentrations (or concentrations within known ranges) of the relevant target species (for instance, of an amine-containing additive such as a detergent additive).

As described above, the colour charts may include colour ranges for two or more different types of fuel, for example for fuels having different initial colours; this allows the test results to be more readily interpreted, whatever the colour of the fuel composition being tested. They may also include a base fuel colour chart, showing the initial colours of a range of different fuel types; the user may then compare the colour of a fuel under test with those shown on the base fuel colour chart, and thereby select the most appropriate colour range chart from those supplied.

The colour charts may include colour ranges for two or more different target species, thus broadening the potential applications of the test.

The kit will suitably also include:
(c) one or more vessels, such as graduated glass tubes, in which to collect and analyse fuel samples;
(d) one or more pipettes for the transfer of fluid samples;
(e) a set of instructions for carrying out the test;
(f) safety equipment, such as one or more pairs of disposable gloves, safety goggles, a container for disposing of sharps or a waste bottle in which to dispose of used fluids;
(g) a solvent or solvent mixture (e.g. a 1:1:1 mixture of iso-propyl alcohol, toluene and acetone) for use in cleaning sample vessels prior to use;
(h) one or more stirrers for ensuring adequate mixing of test fuels and indicator solution;
(i) a light box such as a photographic daylight light box, optionally with batteries and/or means for connecting to a mains power supply, to aid assessment of the test results and their comparison with the colour charts; and/or
(j) a solvent, for example n-heptane or n-hexane with which to dilute test samples.

Of these, the diluting solvent may be particularly important, in particular when testing diesel fuel samples or, for example, lubricating oils which tend to contain relatively high concentrations of dispersant additives. The light box may also be of value in facilitating use of the test kit and accurate interpretation of test results, in particular if there is any tendency for fuel samples to fluoresce on addition of the indicator.

The test kit may in certain cases include apparatus for assessing the spectroscopic response of a test sample to addition of the indicator, for example a spectrophotometer, in particular where such apparatus can be made sufficiently small and portable, and sufficiently easy to use, as to be of practical use in the field.

If an indicator is used which requires developing in order to generate a detectable spectroscopic response, then the test kit may include means for effecting such a development, for example a UV light to enable visualisation of a fluorescent indicator, or one or more additional reagents to add to a test sample in order to develop the indicator, or means for changing the temperature of a test sample.

The kit may contain sufficient indicator to allow more than one test to be carried out. If appropriate (for instance, in the case of a HTBPE indicator), the indicator solution can be provided in a protective environment—thus, for example, it may be provided in darkened glass ampoules which have been sealed under an inert (e.g. argon) atmosphere.

A test kit of the type described above may be used to conduct a simple field test to detect a detergent additive in a diesel fuel, in accordance with the following instructions.

1. Pour a sample of the fuel under test (the “test fuel”) into a glass tube and rate its colour against the base fuel colour chart, positioned on the light box. Based on the observed colour of the test fuel, select the appropriate colour reference chart from those provided. Position the reference chart on the light box in place of the base fuel colour chart.
2. Empty a 10 ml ampoule of trisolvent into one of the glass sample tubes provided, rinse and discard (preferably into the waste beaker provided). Wipe the inside of the glass tube dry with a tissue, ensuring it is completely dry before proceeding to the next stage of the test.
3. Using a plastic wash bottle, transfer 7 ml of n-heptane into the thus-cleaned glass tube so that the meniscus lies on the 7 ml line. Pipette 3 ml of the test fuel into the n-heptane.
4. Break open a 2 ml ampoule of the indicator solution and empty into the n-heptane/test fuel mixture. Stir.
5. Compare the colour of the sample with those shown on the selected reference chart. This will provide the required indication of whether the detergent additive is present in the test fuel and, if so, its approximate treat rate (concentration).

The test should ideally be conducted in a well ventilated area, for health and safety reasons, and to facilitate assessment of the results under subdued artificial lighting or shady conditions. It is preferably conducted at or around 20° C.

All test fuel samples and solvents should be disposed of as toxic waste, if appropriate using the waste beaker provided with the test kit. Broken ampoules should also be appropriately discarded, ideally into a sharps bin provided with the test kit and subsequently by incineration.

What is claimed is:

1. A method for detecting a basic target species in a fuel composition, the method comprising (i) adding to the composition a spectroscopically active indicator which is capable of reacting with the target species, and (ii) detecting the spectroscopic response of the fuel composition to the presence of the indicator.

2. A method for signalling to a user a property of a fuel composition, the method involving including in the composition a target basic species and a spectroscopically active indicator which is capable of reacting with the target species, thereby producing a spectroscopic response in the fuel composition.

3. The method of claim 1 wherein the fuel composition is an automotive gasoline or diesel fuel or a lubricating oil.

4. The method of claim 3 wherein the target species is a detergent or dispersant additive or a constituent thereof.

5. A kit for use in detecting a basic target species in a fuel composition, the kit including (i) a spectroscopically active indicator which is capable of reacting with the target species and (ii) a reference with which to compare the spectroscopic response of a fuel composition to addition of the indicator.

6. The kit of claim 5 wherein the indicator is capable of producing a colour change on reaction with the target species.

7. The kit of claim 5 wherein the indicator is a phenolphthalein indicator.

8. The kit of claim 7 wherein the indicator is tetrabromophenolphthalein ethyl ester (HTBPE).

9. The kit of claim 5 wherein the reference comprises a colour chart.
